(19) United States
(12) Patent Application Publication
(10) Pub. No.: US 2026/0345436 A1
(43) Pub. Date: Nov. 5, 2026

(54) BILATERAL STIMULATION DEVICE

(71) Applicant: Humm Inc., Austin, TX (US)

(72) Inventors: Laura Shires, Austin, TX (US); Austin Shires, Austin, TX (US)

(73) Assignee: Humm Inc., Austin, TX (US)

(21) Appl. No.: 19/662,090

(22) Filed: Apr. 29, 2026

Related U.S. Application Data
(60) Provisional application No. 63/797,622, filed on Apr. 30, 2025.

(51) Int. Cl. A61H 23/02

(52) U.S. Cl. CPC A61H 23/0254; A61H 2201/0157; A61H 2201/5007; A61H 2201/5061

(57) ABSTRACT

Apparatus and associated methods relate to bilateral stimulation. In an illustrative example, a bilateral stimulation device (BSD) includes a left handle and a right handle. Each of the handles are coupled together. Each of the handles are configured to vibrate, and the handles vibrate in an alternating pattern to provide alternating bilateral stimulation, where the left handle vibrates then stops, the right handle vibrates then stops, the left handle vibrates then stops, and so on, until the BSD is turned off by the user. Each of the handles include a controller configured to adjust one or more characteristics of the vibrations. In some embodiments, the left handle may function as an intensity controller and the right handle as a duration controller. In some configurations, either handle may be used to control either parameter, thereby allowing the device to be symmetrical and user-intuitive.

### CROSS-REFERENCE TO RELATED APPLICATIONS

This application is a non-provisional patent application and claims the benefit of U.S. application Ser. No. 63/797,622, titled “BILATERAL STIMULATION DEVICE,” filed by Laura Shires and Austin Shires on Apr. 30, 2025.

This application incorporates the entire contents of the foregoing application(s) herein by reference.

### TECHNICAL FIELD

Various embodiments relate generally to bilateral stimulation devices.

### BACKGROUND

In some industries, helping a user maintain focus is a desirable feature in a product. Devices and methods have been developed for promoting general wellness in individuals.

### SUMMARY

Apparatus and associated methods relate to bilateral stimulation. In an illustrative example, a bilateral stimulation device (BSD) includes a left handle and a right handle. Each of the handles are coupled together. Each of the handles are configured to vibrate, and the handles vibrate in an alternating pattern to provide alternating bilateral stimulation, where the left handle vibrates then stops, the right handle vibrates then stops, the left handle vibrates then stops, and so on, until the BSD is turned off by the user. Each of the handles include a controller configured to adjust one or more characteristics of the vibrations. In some embodiments, the left handle may function as an intensity controller and the right handle as a duration controller. In some configurations, either handle may be used to control either parameter, thereby allowing the device to be symmetrical and user-intuitive. For example, the intensity controller may control the amplitude and/or the frequency of the vibrations, and the duration controller may set the vibration duration on each handle. In some configurations, the duration settings are aligned with natural breathing cycles (e.g., a 5-second inhale and a 5-second exhale), enabling the device to provide haptic feedback in synchrony with common relaxation rhythms.

Various embodiments may achieve one or more advantages. In various embodiments, the BSD may advantageously enable a user to engage in therapeutic bilateral stimulation through both sensory output and intentional bilateral motor input. For example, adjusting the vibration settings using the left and right handle controllers activates both hemispheres of the brain, creating a feedback loop in which motor input complements sensory stimulation as part of the therapeutic experience. Various embodiments may, for example, advantageously enable a user to control the vibrations to their personal preferences. Various embodiments may, for example, advantageously enable the user to control the intensity of the vibrations and the duration of the vibrations of both the handles using the controllers. Various embodiments may, for example, advantageously enable a single controller on the top of the handle to select through numerous intensity modes. Various embodiments may, for example, advantageously enable a controller on the top of the handle to select through numerous duration modes.

The details of various embodiments are set forth in the accompanying drawings and the description below. Other features and advantages will be apparent from the description and drawings, and from the claims.

### BRIEF DESCRIPTION OF THE DRAWINGS

FIG. 1 depicts an illustrative perspective view of an exemplary bilateral stimulation device (BSD) employed in an example use-case scenario;

FIG. 2 depicts an illustrative top view of an example BSD;

FIG. 3 depicts an illustrative bottom view of an example BSD;

FIG. 4 depicts an illustrative perspective view of an example BSD;

FIG. 5 depicts an illustrative bottom view of an example BSD;

FIG. 6 depicts an illustrative top view of an example BSD;

FIG. 7 depicts an illustrative front view of an example BSD;

FIG. 8 depicts an illustrative back view of an example BSD;

FIG. 9 depicts an illustrative side view of an example BSD;

FIG. 10 depicts an illustrative side view of an example BSD;

FIG. 11 depicts an illustrative perspective view of an example BSD;

FIG. 12 depicts an illustrative perspective view of an example BSD;

FIG. 13 depicts an illustrative perspective view of an example BSD;

FIG. 14 depicts an illustrative side view of an example BSD;

FIG. 15 depicts an illustrative side view of an example BSD;

FIG. 16 depicts an illustrative perspective view of an example BSD;

FIG. 17 depicts an illustrative perspective view of an example BSD;

FIG. 18 depicts an illustrative perspective view of an example BSD;

FIG. 19 depicts an internal view of an example BSD;

FIG. 20 depicts an exploded view of an example BSD;

FIG. 21 depicts an exploded view of an example BSD; and

FIG. 22 depicts an internal view of an example BSD.

Like reference symbols in the various drawings indicate like elements.

### DETAILED DESCRIPTION OF ILLUSTRATIVE EMBODIMENTS

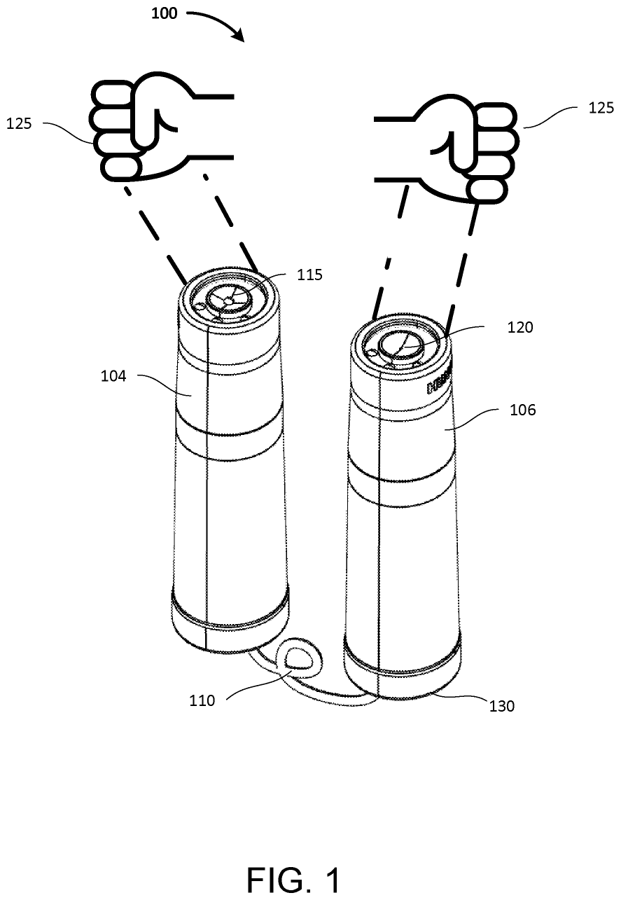

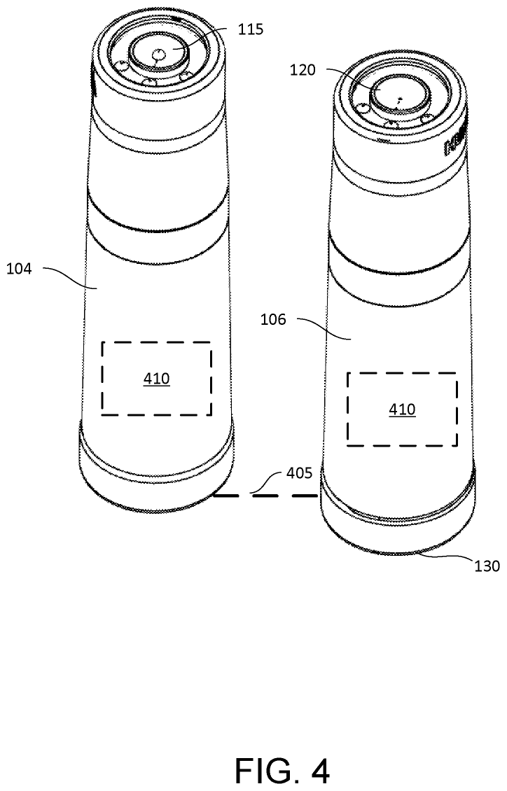

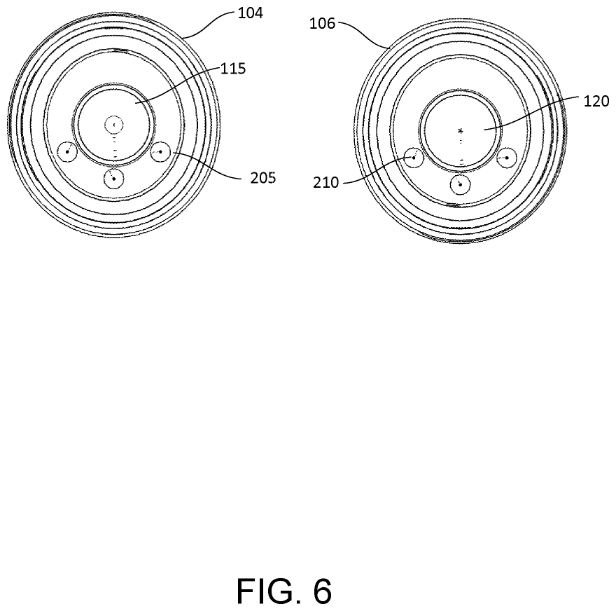

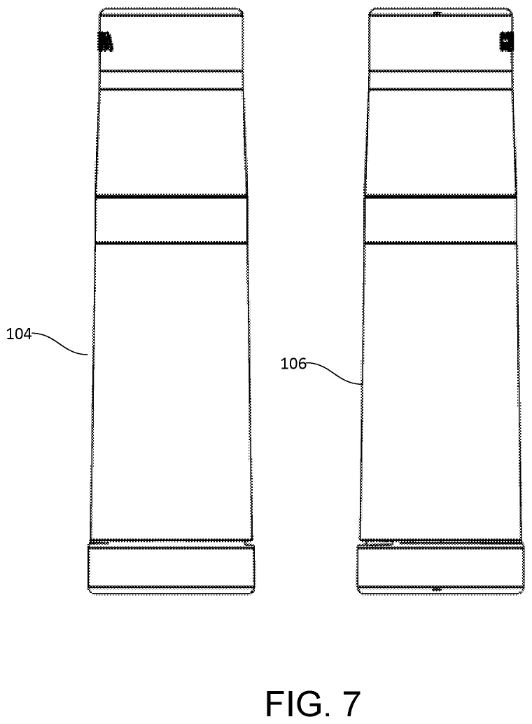

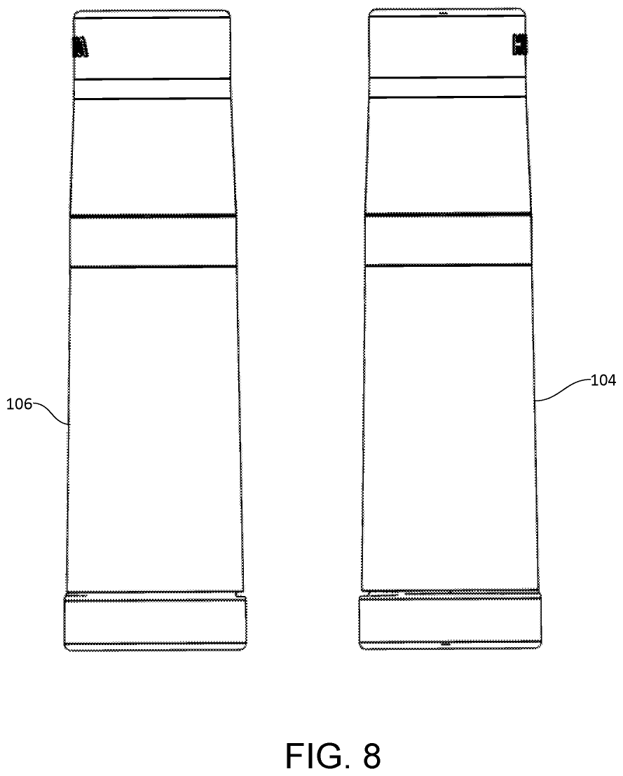

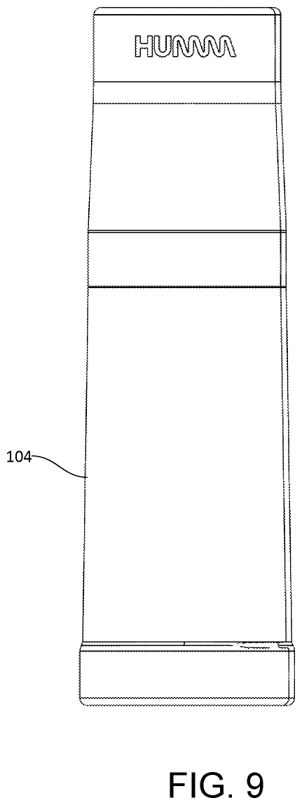

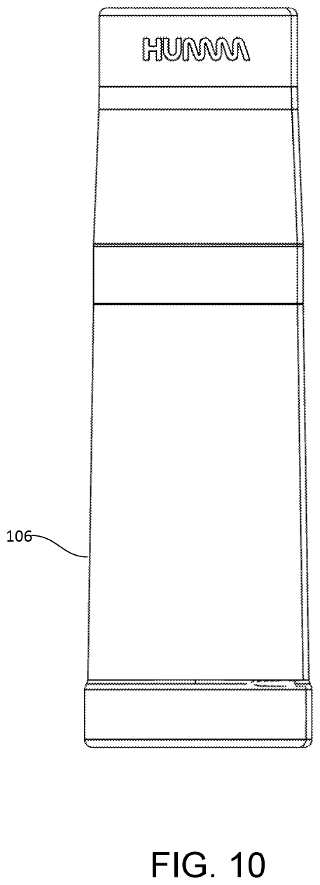

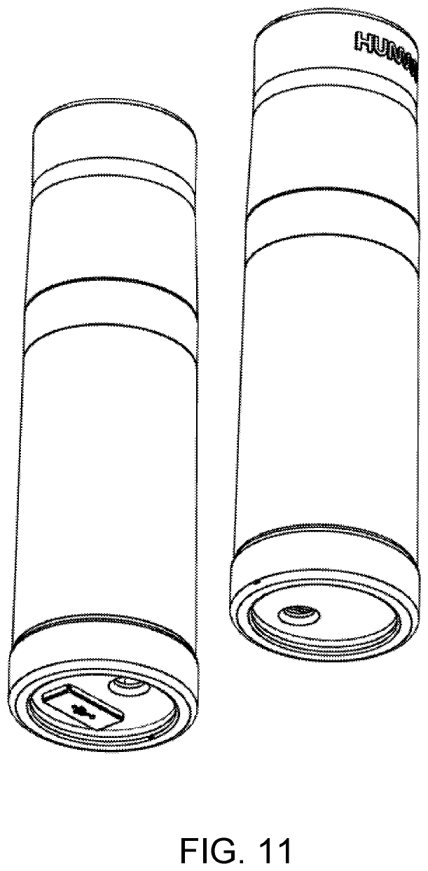

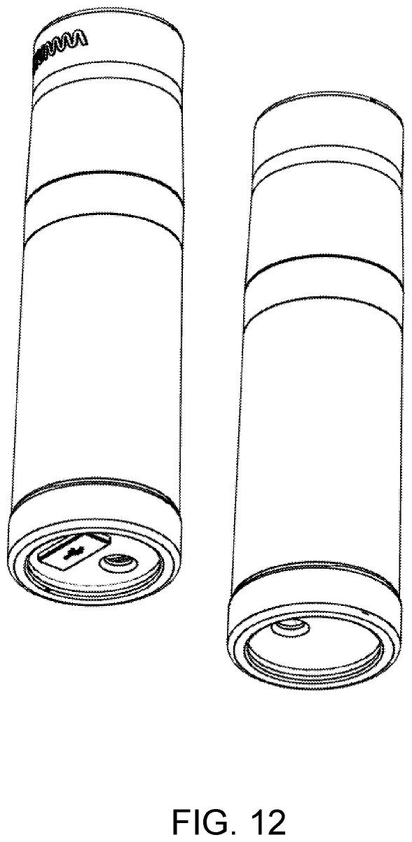

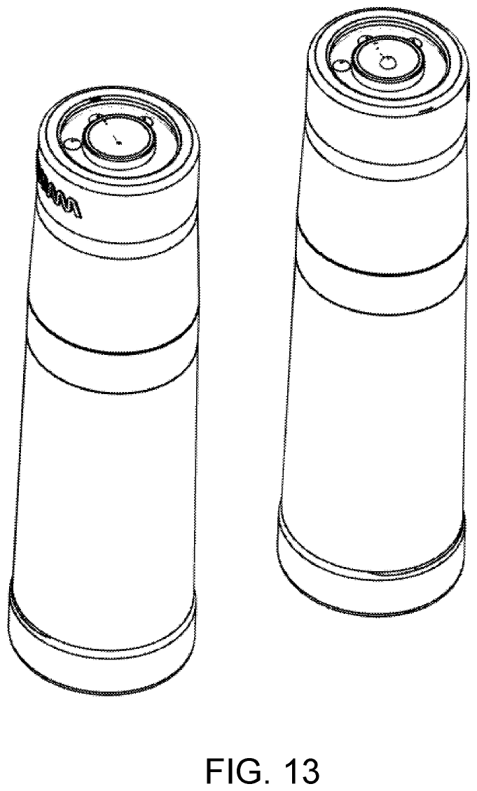

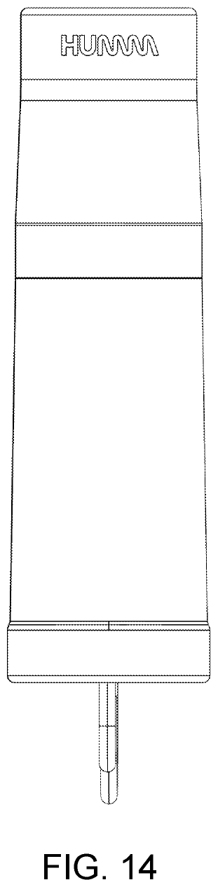

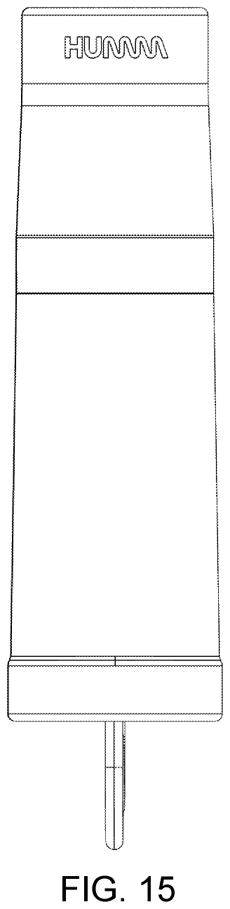

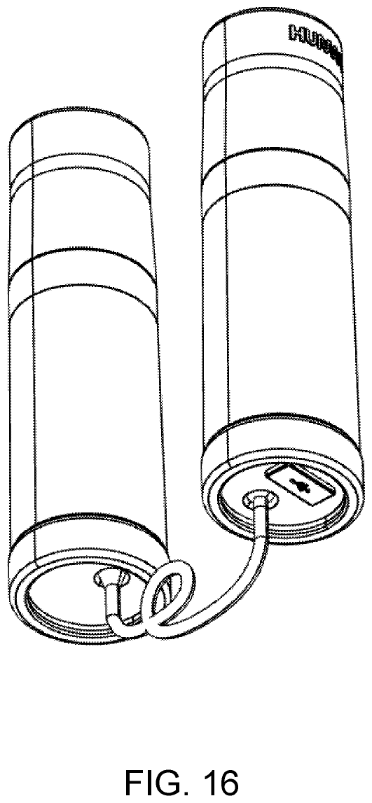

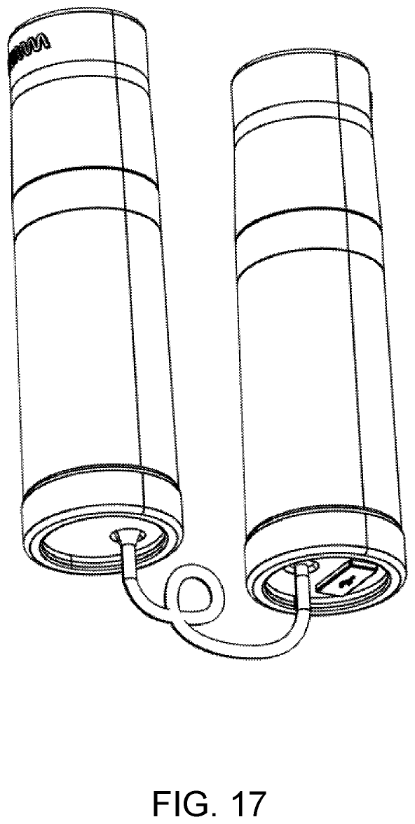

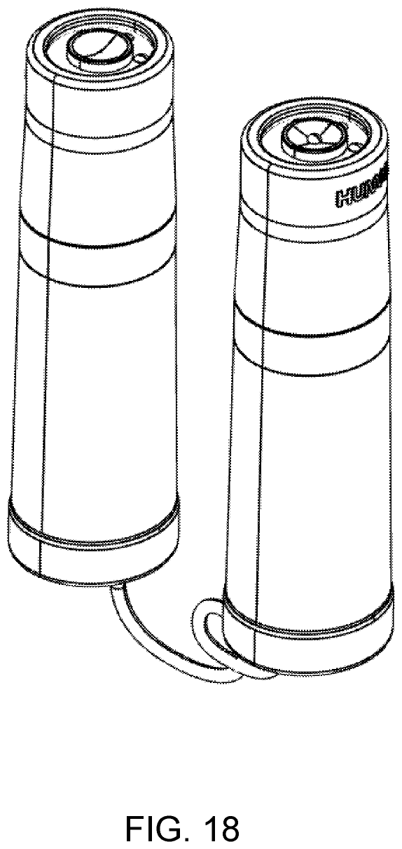

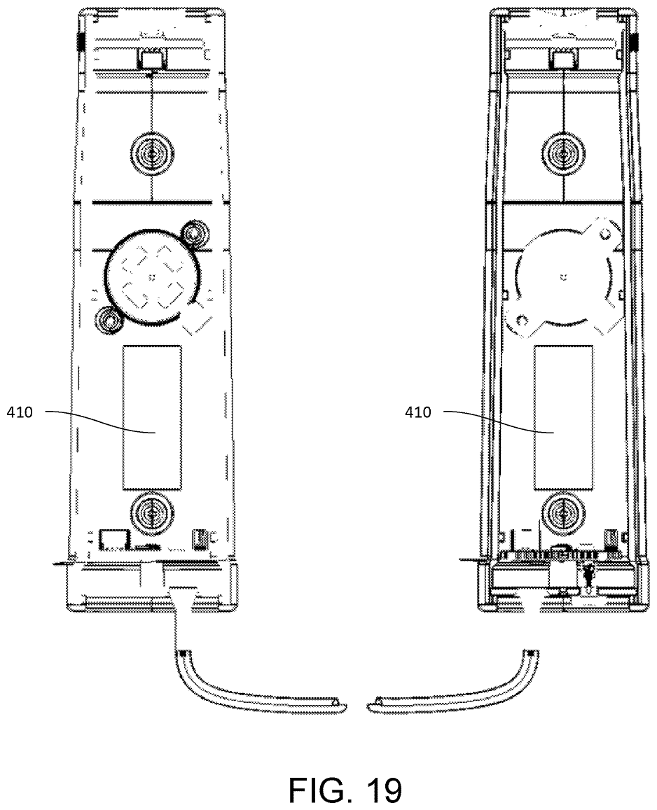

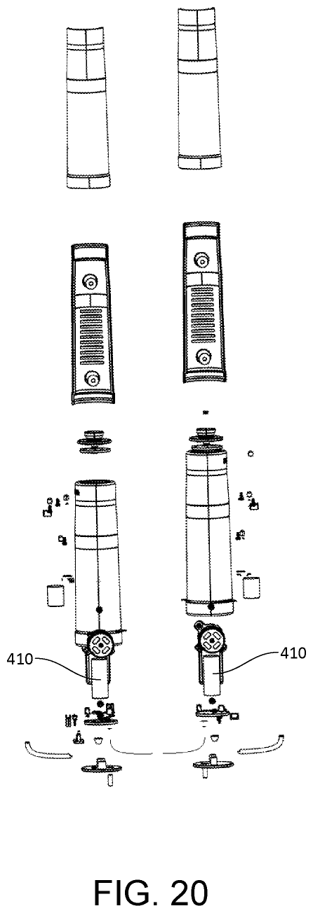

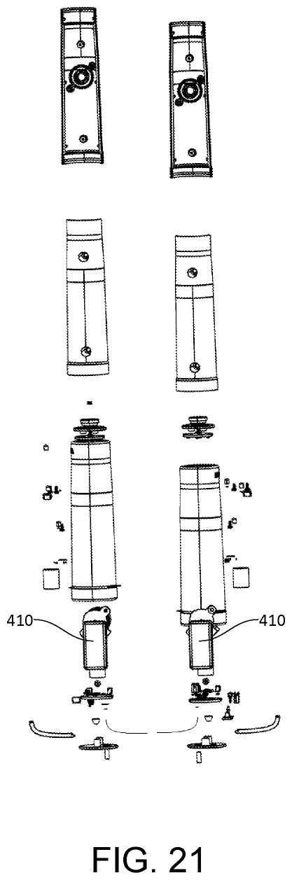

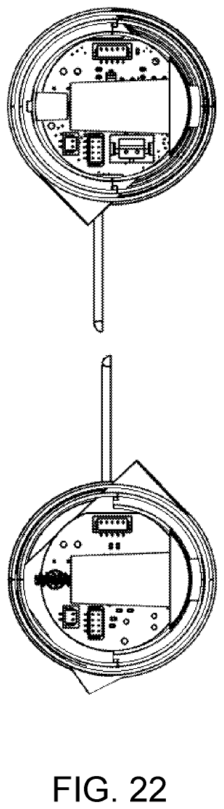

To aid understanding, this document is organized as follows. First, to help introduce discussion of various embodiments, a bilateral stimulation device (BSD) is introduced with reference to FIGS. 1-3 and 14-18. Second, that introduction leads into a description with reference to FIGS. 4-13 of some exemplary embodiments of a BSD. Third, FIGS. 19-22 depict various internal views of an example BSD.

FIG. 1 depicts an illustrative bilateral stimulation device (BSD) employed in an example use-case scenario. A bilateral stimulation device (BSD 100) includes a left handle 104 and a right handle 106. Each of the handles 104, 106 are coupled together via a connecting cable 110. Each of the handles 104, 106 are configured to vibrate. In some embodiments, the handles may be configured to vibrate in an alternating pattern to provide alternating bilateral stimulation—where the left handle vibrates then stops, the right handle vibrates then stops, the left handle vibrates then stops, and so on—until the BSD is turned off by the user. In some examples, when the left handle 104 vibrates, the right handle 106 may not and vice versa. The left handle 104 includes an intensity controller 115. The intensity controller may, for example, control the amplitude and/or the frequency of the vibrations. This may, for example, advantageously enable a user to control the vibrations to their personal preferences. The right handle 106 includes a duration controller 120. The duration controller 120 may, for example, set the duration of the vibration on each handle 104, 106 to five seconds. This may, for example, advantageously enable the user to set the device to their desired preferences. These durations may promote relaxation by synchronizing haptic output with the user's breathing pattern (e.g., a 5-second inhale and a 5-second exhale), thereby reinforcing parasympathetic activation through temporal alignment. In some examples, other timing patterns, such as 3 -3 or 2 -2 second inhale/exhale cycles, may accommodate different breathing practices or stress levels.

In some examples, the BSD 100 includes the two handles 104, 106 configured to vibrate connected by the connecting cable 110, the two handles 104, 106 each including buttons configured to control the vibrations.

In various embodiments, the connecting cable 110 operably couples the handles 104, 106 together. This may, for example, advantageously enable the user to control the intensity of the vibrations and the duration of the vibrations of both the handles 104, 106 using the controllers 115, 120.

In some implementations, either handle 104, 106 may function as an intensity controller or a duration controller, thereby allowing the device to be symmetrical and user-intuitive. In some implementations, the intensity controller 115 may be on the right handle 106. The duration controller 120 may, for example, be on the left handle 104. The intensity controller 115 may, for example, be a button, switch, or touch-sensitive surface. For example, a set number of modes can be clicked through using the intensity controller 115. In some examples, five different modes may be selected by the intensity controller 115. The first mode may be the least intense, the second mode may be more intense than the first mode, the third mode may be more intense than the second mode, the fourth mode may be more intense than the third mode, and the fifth mode may be the most intense. When pressing the intensity controller 115 on the fifth mode, the next mode may, for example, be the first mode. This may, for example, advantageously enable a single button on the top of the handle 104 to select through numerous intensity modes. In some examples, the duration controller 120 may, for example, be a button, switch, or touch-sensitive surface. For example, a set number of modes can be clicked through using the duration controller 120. In some examples, five different modes may be selected by the duration controller 120. The first mode may be the shortest duration, the second mode may be longer than the first mode, the third mode may be longer than the second mode, the fourth mode may be longer than the third mode, and the fifth mode may be the longest mode in duration. When pressing the duration controller 120 on the fifth mode, the next mode may, for example, be the first mode. This may, for example, advantageously enable a single button on the top of the handle 106 to select through numerous duration modes. In some implementations, the intensity controller 115 may be pressed for several seconds to turn the BSD 100 on and off. In some examples, the duration controller 120 may be pressed for several seconds to turn the BSD 100 on and off. In some implementations, the intensity controller 115 and the duration controller 120 may be simultaneously pressed for several seconds to turn the BSD 100 on and off.

In various implementations, each of the handles 104, 106 include vibrating elements. The vibrating elements may, for example, be configured to vibrate the handles. The intensity controller 115 and the duration controller 120 may, in some examples, be operably coupled to the vibrating elements. This may, for example, enable the vibrating in each of the handles to occur. In some examples, the vibrating elements may include, but are not limited to, eccentric rotating mass (ERM) motors, linear resonant actuators (LRA), voice coil actuators (VCA), piezoelectric elements, magnetostrictive actuators, and/or soft robotic components. In some implementations, an ERM may, for example, advantageously produce strong vibrations. An LRA or VCA may, for example, advantageously be configured to vibrate at one set frequency (e.g., approximately 136 Hz) while the intensity (vibration amplitude) is varied across multiple settings. An LRA or VCA may, for example, advantageously be configured to produce nuanced and stable haptic vibrations.

In some embodiments, the intensity controller 115 may, for example, be configured to enable a user to select from a predefined set of frequencies, in the range of 100 Hz to 450 Hz, known for their calming or grounding effects. The selected frequency remains constant while the intensity (vibration amplitude) is varied across multiple settings. This enables the user to perceive differences in vibration strength without altering the intended sensory pitch or physiological effect. In some embodiments, the duration controller 120 may be repurposed to enable a user to select from a predefined set of frequencies, and the intensity controller 115 may be configured to only enable a user to adjust the amplitude of the vibrations. In some examples, the duration of the vibrations may be held constant.

In some embodiments, the intensity controller 115 and/or the duration controller 120 may be repurposed to enable a user to select from a predefined set of vibrational patterns that may, for example, synchronize with rhythmic breathing techniques, such as box breathing or 4-7-8 breathing, which are known for their calming effects.

In some embodiments, the handles 104, 106 are configured to be held with the user's hands 125. The handles 104, 106 may, for example, be held in a neutral position. In some examples, the handles 104, 106 may be rested on a user's legs.

In some embodiments, the connecting cable 110 may, for example, be sized for a person to hold the BSD 100 comfortably on either side of their body. The connecting cable 110 may, for example, be durable. This may, for example, advantageously increase the longevity of the cable 110. The connecting cable 110 may, for example, be flexible. This may, for example, advantageously enable bending of the cable 110.

The connecting cable 110 may, for example, be removably attached to the handles 104, 106. This may, for example, enable the connecting cable 110 to be stored when the BSD 100 is not in use. This may, for example, advantageously prevent the connecting cable 110 from being damaged if the BSD 100 is stored improperly. This may, for example, advantageously enable the connecting cable 110 to be replaced when a used connecting cable 110 wears out.

In some embodiments, the connecting cable 110 may be retractable. The retractable connecting cable may, for example, shorten the connecting cable. This may, for example, advantageously enable the cable to be shortened when not in use.

In some embodiments, the handles 104, 106 include charging ports 130 for a rechargeable battery located inside one or both handles 104, 106. As depicted in FIG. 1, the charging ports 130 may, for example, be positioned on the bottom side of one or both handles 104, 106, on the left side of the left handle 104, on the right side of the right handle 106, or in a combination thereof. The charging ports 130 may, for example, enable the BSD 100 to be charged. In some examples, a charging port 130 may include or operate as a charging interface, such as a wired connector (e.g., a USB-type port) or a wireless charging element (e.g., inductive coupling).

In various embodiments, the intensity controller 115 may be a dial. The dial may, for example, adjustably control the amplitude and/or frequency of the vibrations. As the dial is turned right or left, the dial may, for example, increase or decrease the amplitude and frequency of the vibrations. In some examples, the duration controller 120 may be a dial. The dial may, for example, adjustably control the duration of the vibrations. As the dial is turned right or left, the dial may, for example, increase or decrease the duration of the vibrations.

In some embodiments, only one of the handles 104, 106 may vibrate at a time. For example, the left handle 104 may vibrate for a certain duration. Then, after the duration has ceased, the left handle 104 stops vibrating and the right handle 106 begins vibrating for a certain duration. The BSD 100 repeats this process until the total duration of the BSD 100 session.

In various embodiments, the handles 104, 106 may vibrate simultaneously. In some embodiments, there is an overlap in the left handle 104 and the right handle 106 vibrations. For example, the left handle 104 may vibrate for a certain duration, and then before the duration has stopped, the right handle 106 begins vibrating for a certain duration. The left handle 104 then stops vibrating before the right handle 106 stops vibrating. The BSD 100 repeats this process until the BSD 100 is turned off.

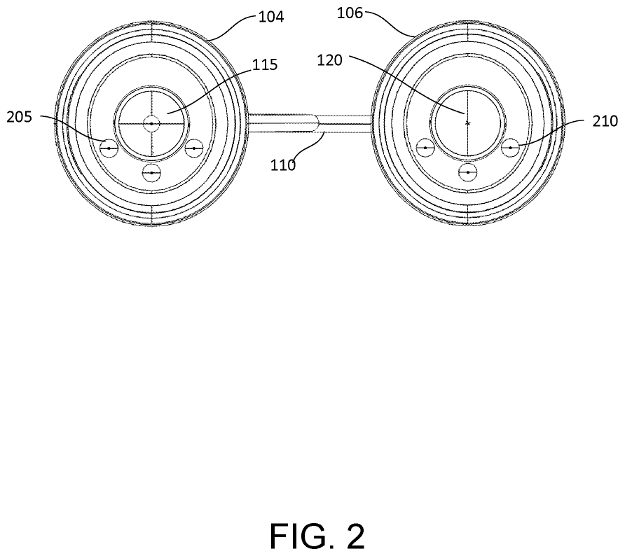

FIG. 2 depicts an illustrative top view of an example BSD. The handles 104, 106 include indicators 205, 210. The indicators 205, 210 may, for example, be LED lights. The indicators 205 on the left handle 104 may, for example, be configured to indicate the mode that the intensity controller 115 set. The intensity controller 115 may set the intensity of the vibration on the fourth mode. The indicators 210 on the right handle 106 may, for example, be configured to indicate the mode that the duration controller 120 set. The duration controller 120 may set the duration of the vibration on the third mode. The indicators 205, 210 may, for example, advantageously communicate the set modes to the user. For example, this may advantageously enable the user to determine whether the desired vibration and duration has been reached. In some embodiments, one or both set of indicators 205, 210 may be configured to act as a power indicator to communicate to the user when the BSD 100 rechargeable battery needs to be charged, is currently charging, and/or is fully charged. In some embodiments, one or both set of indicators 205, 210 may be configured to signal to the user that the device is turning on. In some embodiments, one or both set of indicators 205, 210 may be configured to signal to the user that the device is turning off.

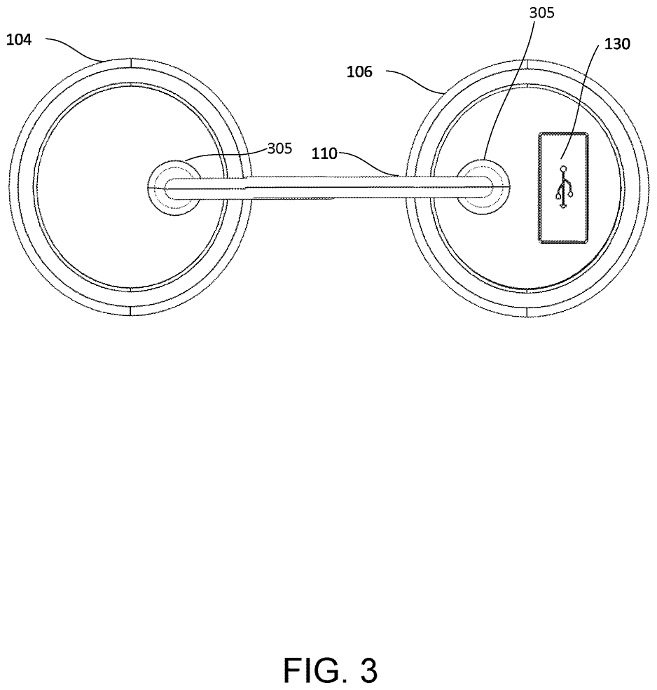

FIG. 3 depicts an illustrative bottom view of an example BSD. The connecting cable 110 connects to an anchor point 305 on each of the handles 104, 106. The anchor points 305 may, for example, be configured to couple with the ends of the connecting cable 110. This may, for example, operably couple each of the handles 104, 106 together. One or both handles 104, 106 may, for example, include a charging port 130 to charge the BSD 100 rechargeable battery.

FIG. 4 depicts an illustrative view of an example BSD. The handles 104, 106 may, for example, include a wireless connection 405. The wireless connection 405 may, for example, operably couple the handles 104, 106. The wireless connection 405 may, for example, enable a user to operate the device without a physical connection between the handles 104. 106. In some examples, the BSD 100 may be operably connected with the connecting cable 110 and the wireless connection 405. This may, for example, expand the number of use cases for the device. For example, if a user was using the connecting cable 110 and the connecting cable gets damaged, the user can switch to the wireless connection 405 to continue using the device. This may, for example, be advantageous when you are on a plane and cannot readily purchase a new connecting cable 110. One or both handles 104, 106 may, for example, include a charging port 130 to charge the BSD 100 rechargeable battery.

In some examples, the wireless connection 405 may be facilitated by wireless connection modules 410. In various examples, the wireless connection modules 410 disposed in each of the handles 104, 106. The wireless connection module 410 may, for example, be a Bluetooth module. In some examples, the wireless connection modules 410 operably couples each of the handles 104, 106 to each other. This may, for example, enable the handle 104 to control some of the functionality of the handle 106 and enable the handle 106 to control some of the functionality of the handle 104.

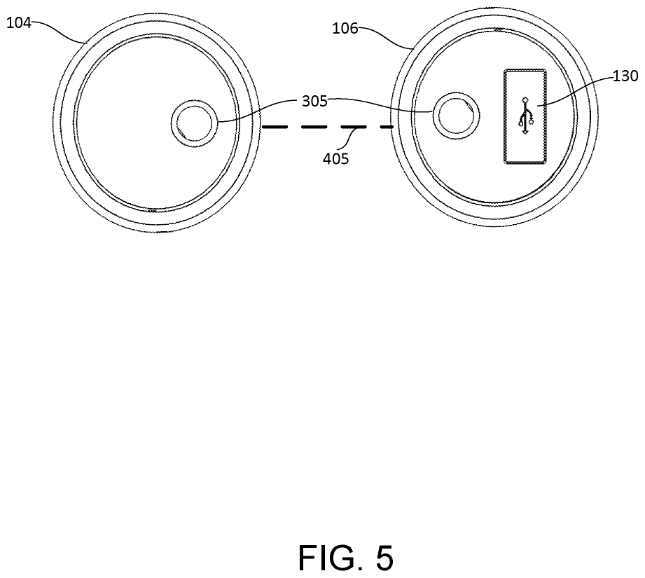

FIG. 5 depicts an illustrative bottom view of an example BSD. There may be a connecting cable 110 connecting to an anchor point 305 on each of the handles 104, 106. The anchor points 305 may, for example, be configured to couple with the ends of the connecting cable 110. This may, for example, operably couple each of the handles 104, 106 together, in addition to a wireless connection 405. One or both handles 104, 106 may, for example, include a charging port 130 to charge the BSD 100 rechargeable battery.

Although various embodiments have been described with reference to the figures, other embodiments are possible.

Although an exemplary system has been described with reference to FIG. 1-22, other implementations may be deployed in other industrial, scientific, medical, commercial, and/or residential applications.

In some embodiments, the stimulation frequency remains constant across modes, while intensity and duration are independently varied. This constancy of frequency may aid in creating a stable rhythmic pattern associated with relaxation responses. In some embodiments, the BSD operates at a consistent vibration frequency of approximately 136 Hz. This frequency, sometimes referred to as the Om Frequency, holds historical and cultural significance in various traditions, particularly in meditative practices. The use of this frequency may enhance the calming and centering effects of the BSD, contributing to its therapeutic value.

In some embodiments, the handles may, for example, be configured to support a user's neutral grip at rest. The shape of the handles may, for example, taper towards the controller end. The handles may, for example, be made of a thermoplastic elastomer (TPE). TPE may, for example, be hypoallergenic, phthalate-free, latex-free, and BPA-free. This may, for example, enable significantly more users to grip the handles. TPE may, for example, be cost effective, minimizing the cost of producing the BSD, which advantageously reduces the cost of purchasing the BSD. TPE may, for example, allow vibrations to be felt. This may, for example, allow for the vibrations of the handles to still be felt by the user. TPE may, for example, be lightweight. This may, for example, advantageously reduce shipping costs. TPE may, for example, be easy to sanitize. This may, for example, advantageously enable the BSD to be cleaned after uses. TPE may, for example, be durable. The durability of TPE may, for example, protect the electronics in the BSD from being damaged when dropped. TPE may, for example, be colorable. The colorability of the TPE, for example, advantageously enable customization of the BSD. In some embodiments, the handles may be made of silicone.

In some embodiments, the BSD may, for example, include a grip detector on each of the handles. The grip detector may, for example, be configured to detect when each of the handles is gripped. When the grip detector detects each of the handles being gripped, the BSD may, for example, automatically turn on. The BSD may, in some examples, stay activated until the grip detector detects that one or both of the handles is no longer being gripped. This may, for example, advantageously enable a user to pick up the BSD and immediately begin a session. In some embodiments, the BSD may include automatic sleep modes or battery conservation features, wherein the device reduces power output or enters a standby state after a predetermined period of inactivity. In some embodiments, the BSD may further include energy harvesting elements configured to capture ambient energy, such as motion-based generators, thermal gradients, or vibration harvesting systems, to extend battery life during operation or standby.

In various embodiments, the BSD may be of varying sizes. The BSD may, for example, include a size ideal for an adult's hand shape as well as a size ideal for a child's hand shape.

In some embodiments, the BSD may offer handles in various ergonomic shapes to accommodate user preferences or specific use cases. For example, the handles may be cylindrical, oval, flattened, or contoured to support different grip styles. Handle shape variations may optimize for factors such as comfort, hand size, tactile feedback, or ease of portability.

In various implementations, the BSD may include a delayed ramp-up period, during which the vibration gradually increases after the BSD is turned on. In various implementations, the BSD may include a delayed ramp-down period, during which the vibration gradually decreases after the user presses the controller to turn the BSD off but before the BSD shuts off. In some examples, the ramp-down period may be configured to decrease the vibration characteristics prior to deactivation.

In various implementations, the BSD may emit a series of brief pulses to signal a low battery state. The brief pulses may, for example, occur after the user presses the controller to turn the BSD on but before the first set of alternating bilateral stimulation vibrations are generated. The brief pulses may, for example, occur after the user presses the controller to turn the BSD off but before the BSD shuts off.

In various implementations, the BSD may be waterproof. The waterproof BSD may, for example, be used in wet environments, such as during a bath, shower, cold plunge session, or in outdoor settings involving rain or snow. The BSD may, for example, be water-resistant. This may, for example, advantageously prevent moisture, such as sweat or splashes, from entering the BSD.

In some embodiments, the BSD may be temperature and humidity resistant. The BSD may, for example, be operable across a wide range of environmental conditions, such as from approximately −20 degrees Fahrenheit to approximately 180 degrees Fahrenheit. In some embodiments, the BSD may be configured for use in high-temperature, high-humidity environments such as saunas, steam rooms, or hot yoga studios. In some examples, the BSD may also maintain functionality during exposure to cold environments, including cold plunge sessions, outdoor winter conditions, or post-workout cool-downs in cold weather.

In various embodiments, the handles may be enclosed in a cushion layer. The cushion layer may, for example, provide additional layers of comfort for the user while also maintaining the functionality of the BSD.

In some implementations, the handles may be perforated. The perforations of the handle may, for example, advantageously reduce the total weight of the handle. The perforations may, in some examples, dampen the sound of the vibrations.

In various implementations, the BSD includes a rechargeable battery.

In various embodiments, the BSD may include a memory controller. The memory controller may, for example, store the user's preferred intensity and duration settings for future use. The memory controller may, in some examples, store several combinations of intensity and duration. This may, for example, advantageously enable multiple users to store their preferred combinations of intensity and durations. The memory controller may, for example, be a button, switch, or touch-sensitive surface.

In some implementations, one or more sensory elements may be incorporated into the BSD to enhance the user experience. The sensory element may, for example, include a visual element. The visual element may, for example, be a light that turns on and synchronizes with each handle's vibrations. The sensory element may, for example, include an auditory element. The auditory element may, for example, be a sound that plays from the handle and synchronizes with each handle's vibrations. The sensory element may, for example, include active temperature modulation elements, such as integrated heating pads or thermoelectric cooling devices (e.g., Peltier elements), configured to adjust the surface temperature of the handles during a session. Temperature adjustments may be synchronized with stimulation patterns to promote relaxation, alertness, or other therapeutic outcomes. In some embodiments, the BSD may combine multiple sensory modalities, such as tactile stimulation, visual indicators, auditory cues, and temperature modulation in a coordinated fashion to enhance therapeutic outcomes.

In various embodiments, the BSD may be configured to vary the waveform of the vibrations delivered through the handles. In addition to controlling vibration intensity, duration, and frequency, the BSD may generate different vibration profiles, such as linear ramps, sinusoidal waves, square waves, or pulsed bursts. In some examples, users may select among predefined waveform patterns to customize the sensory experience, supporting different use cases such as relaxation, alertness, grounding, or focus. The waveform adjustments may be applied independently or in combination with intensity and duration settings.

In some embodiments, the BSD may be used with a docking station configured to charge one or more devices. The docking station may include connectors or charging interfaces configured to mate with the charging ports of the BSD. In some examples, the docking station may support wired charging through physical contacts (e.g., pogo pins, USB-type connectors) or wireless charging through inductive elements. The docking station may accommodate a single BSD unit or multiple BSD units simultaneously, providing both charging functionality and organized storage.

In some embodiments, the BSD may be used with blankets, weighted blankets, wraps, or other textile accessories. These accessories may include integrated or attachable pockets, compartments, or housings designed to securely retain one or both handles of the BSD. The pockets may be positioned to enable bilateral stimulation across different areas of the user's body while allowing hands-free operation. In some examples, the pockets may be sewn, bonded, zippered, magnetically attached, affixed with hook-and-loop fasteners (e.g., Velcro), or otherwise affixed to the textile surface. Flexible cable management features may also be incorporated to maintain connectivity between handles where needed. In some embodiments, the BSD handles may be removably secured within integrated or attachable pockets, enabling dynamic repositioning across different areas of the textile accessory to accommodate user preferences during bilateral stimulation sessions. In wired configurations, flexible cable management features may also be incorporated to maintain a clean and unobtrusive setup.

In various embodiments, the BSD handles may include removable and replaceable outer covers. These covers may be designed to customize the tactile feel, color, weight, or material properties of the handles. For example, covers may be constructed from different thermoplastic elastomers, fabrics, silicones, or composite materials to optimize grip, comfort, or aesthetic appeal. In some examples, swappable covers may include embedded features such as perforations, texturing, or antibacterial treatments. In some embodiments, swappable handle covers may further include user-customized markings, such as engraved text, etched designs, or monogrammed identifiers. The personalized markings may be formed by laser etching, embossing, debossing, chemical printing, or other methods. Personalized covers may enable users to individualize their devices for aesthetic, organizational, or therapeutic purposes.

In some embodiments, the BSD may be provided with a protective travel case configured to store and transport the device. The case may include dedicated compartments for each handle, the connecting cable, and charging accessories. In some examples, the case may feature molded internal structures, cushioning materials, water-resistant fabrics, or impact-resistant shells to protect the BSD during travel. The travel case may also include integrated cable management features and external attachment points for portability.

In certain embodiments, the handles of the BSD may include magnetic elements that enable the handles to interlock or align with one another when not in use. The magnetic interlocking may assist in storage, transport, or organizational arrangements, and may optionally support specific use modes where the handles operate in tandem.

In various embodiments, the BSD may be configured to accommodate different types of vibration actuators, such as linear resonant actuators (LRA), voice coil actuators (VCA), or eccentric rotating mass (ERM) motors. In some examples, actuator modules may be swappable, allowing users or manufacturers to select a desired actuator type based on performance characteristics such as amplitude, frequency stability, efficiency, or sound level.

In some embodiments, the BSD may be adapted for use in animal therapy applications. For example, the device may be integrated into bedding, crate liners, wearable vests, or other textile accessories designed to promote relaxation and comfort for domestic pets, service animals, or livestock. The bilateral tactile stimulation delivered by the BSD may be adjustable with respect to amplitude, frequency, duration, waveform, and/or timing patterns, and may be optimized for animal physiology and behavioral responses. In some examples, the stimulation profiles may include adaptive features responsive to detected environmental or physiological indicators, such as motion, temperature, stress levels, or restfulness states. For instance, the BSD may adjust vibration characteristics dynamically based on an animal's activity level or environmental conditions. The control interfaces may be configured for caretaker operation, remote activation, or automatic cycling, allowing users to manage stimulation patterns tailored to the needs of individual animals. These configurations may support use cases such as promoting relaxation, supporting recovery, facilitating behavioral conditioning, or enhancing emotional well-being in animals exposed to stressful or demanding environments.

In some embodiments, the BSD may include alternative user interaction systems beyond direct mechanical controllers located on each handle. For example, the device may detect bilateral user engagement through dynamic touch sensing, grip pressure variation, or proximity sensors configured to adjust stimulation parameters based on physical interaction with either or both handles. In certain implementations, the BSD may include bilateral stimulation protocols requiring periodic user interaction from both sides of the device, independent of the specific input mechanism employed. In further embodiments, the BSD may incorporate responsive stimulation adjustment, wherein the vibration characteristics, such as intensity, waveform, or timing, dynamically adapt based on detected bilateral touch, pressure, or user engagement patterns. The system may also implement bilateral feedback loops, where alternating motor input from the user drives corresponding sensory output adjustments. In yet other embodiments, user input controllers may be located externally from the handles, such as via wireless accessories or software-based applications, while still maintaining intentional bilateral motor engagement as part of the therapeutic process. In some implementations, the BSD may also include a session logging feature configured to record user interaction patterns, vibration settings, durations of use, and environmental conditions, enabling future analysis for therapeutic optimization or user self-tracking. In some embodiments, the BSD may be configured for external system integration, wherein control of the stimulation parameters may be coordinated via third-party software, applications, or wearable ecosystems. In some implementations, session data recorded by the BSD may be uploaded to cloud storage for remote access, analysis, or coaching integration.

In some embodiments, multiple BSD devices may be wirelessly or physically synchronized to operate in coordinated bilateral stimulation patterns across different users. For example, a group of users may each hold a BSD handle set, with the devices vibrating in synchronized or complementary patterns to facilitate group therapy sessions, stress reduction programs, or social emotional regulation exercises.

In various implementations, the BSD may be used to promote relaxation, manage stress, and support emotional well-being, which, as part of a healthy lifestyle, may enhance resilience and quality of life. For example, bilateral stimulation delivered by the BSD may help users maintain a sense of calm and self-regulate during periods of heightened stress.

In some embodiments, each of the two stimulation devices includes a wireless transceiver configured to broadcast updated stimulation parameters to its counterpart using a one-way, peer-to-peer communication model. When a user adjusts a stimulation parameter such as intensity or duration using a local control interface, the device may transmit a wireless message conveying the new parameter value. The counterpart device passively listens for such messages and updates its internal stimulation logic accordingly. Unlike master-slave architectures, both devices may independently send or receive such broadcasts, and no device exercises continuous control over the other's operation. Timing synchronization between the devices may be achieved via a shared startup trigger or synchronized internal clock, after which both devices autonomously execute rhythmic bilateral stimulation based on shared parameters, without requiring ongoing coordination. This architecture enables symmetrical user control and synchronized tactile feedback without the need for centralized control, bidirectional communication, or external software.

In some implementations, the BSD includes handles, each of the handles extending longitudinally in an upward direction defining a top side, the top side of each of the handles having controllers arranged thereon, the controllers being configured to operably control a vibration element in each of the handles.

In various embodiments, each handle may include a vibration module disposed within the interior of the handle. The vibration module may be mounted within the handle housing such that vibration energy is transmitted through the handle body and perceptible to the user's hand during operation. In some embodiments, the vibration module may be positioned generally along the longitudinal axis of the handle.

In various implementations, in operation, the vibration modules may vibrate the handles in response to button inputs, producing tactile stimulation perceptible to the user through each hand. In some embodiments, the vibration modules may operate in an alternating bilateral pattern. In some embodiments, the vibration modules may operate simultaneously or in partially overlapping sequences. The button-based control may, for example, allow the user to initiate and modify vibration behavior without requiring external devices or interfaces.

In some embodiments, pressing and holding one button for a predetermined time activates or deactivates both vibration modules. In various examples, pressing and holding both buttons for a predetermined time activates or deactivates both vibration modules. In various embodiments, repeated actuations of a button cycle through discrete vibration modes. The buttons may be mechanical switches, capacitive touch elements, pressure-sensitive inputs, or other user-actuatable input mechanisms without departing from the scope of the device.

In some implementations, a stimulation parameter (e.g., vibration amplitude, vibration intensity, vibration frequency, waveform selection, or vibration duration) may be selectable among a predefined set of discrete mode values stored by the controller (e.g., in memory as a lookup table of parameter values). Upon each user actuation of the controller, the controller may increase or decrease an index corresponding to the discrete modes and apply the stimulation parameter value associated with the newly selected mode. As used herein, a “mode” may correspond to a discrete value of a stimulation parameter.

Because the buttons are arranged directly on the longitudinally extending handles and the vibration modules are disposed within the same handles, the device enables self-contained bilateral stimulation using direct physical interaction alone. This configuration reduces complexity and enhances portability while maintaining precise user control over the vibration output.

In some examples, the intensity controller 115 may be operable in several intensity modes, such as a first, second, and third intensity mode corresponding to progressively increasing stimulation amplitudes. The intensity controller 115 may be implemented as a user-actuatable button and configured such that successive actuations cycle sequentially through the available modes in a repeating loop. Selection of a given intensity mode may, for example, be visually indicated by illumination of a corresponding indicator positioned on the intensity handle, with each mode associated with a different indicator position, while stimulation output corresponding to the selected mode is applied. In some implementations, changes to the intensity mode may take effect asynchronously relative to bilateral stimulation timing, such that an intensity adjustment made while one handle is active is applied when the opposing handle next becomes active. In some examples, this may advantageously preserve continuity and rhythm of alternating stimulation without introducing additional haptic events.

In some implementations, the duration controller 120 may be configured to operate in a plurality of duration modes, such as a first, second, and third duration mode corresponding to different stimulation time intervals for each handle activation. The duration controller 120 may, for example, be implemented as a user-actuatable control on a duration handle. The duration controller 120 may, in some examples, be configured such that successive actuations cycle through the available duration modes in a repeating sequence. Selection of a given duration mode may, for example, be visually indicated by illumination of a corresponding indicator positioned on the duration handle, with each mode associated with a position. In some implementations, changes to the duration mode take effect immediately upon selection, such that subsequent stimulation cycles reflect the newly selected duration without interrupting an active bilateral rhythm. This configuration may, in some implementations, advantageously allow a user to adjust stimulation timing dynamically, including mid-session and independently of intensity adjustments. In some examples, stimulation parameters and vibration characteristics may be interchangeable terms.

In some implementations, the duration controller may be configured such that each duration mode corresponds to a respective discrete duration value selected from a predefined set of duration values. The predefined set of discrete duration values may, for example, be stored in memory as a table or list, and the duration controller may maintain a current-mode index referencing the table. In response to each actuation (e.g., a button press, touch input, or other user input), the duration controller may advance the index to a next duration value and set the vibration duration accordingly.

A number of implementations have been described. Nevertheless, it will be understood that various modifications may be made. For example, advantageous results may be achieved if the steps of the disclosed techniques were performed in a different sequence, or if components of the disclosed systems were combined in a different manner, or if the components were supplemented with other components. Accordingly, other implementations are contemplated within the scope of the following claims.

What is claimed is:

1. A bilateral stimulation device comprising:
a first handle and a second handle electrically coupled via a cable;
at least one button arranged on each of the first handle and the second handle;
a first vibration module disposed in the first handle being configured to vibrate the first handle;
a second vibration module disposed in the second handle being configured to vibrate the second handle; and,
each of the at least one buttons being configured to directly control a stimulation parameter of the first vibration module and the second vibration module.

2. The bilateral stimulation device of claim 1, wherein one of the buttons further comprises a controller configured to adjust a stimulation parameter of the first vibration module and the second vibration module.

3. The bilateral stimulation device of claim 2, wherein the controller is configured to cycle through a predefined set of discrete values of the first stimulation parameter in response to actuation.

4. The bilateral stimulation device of claim 1, wherein one of the buttons further comprises a duration controller configured to control a vibration duration of the first vibration module and the second vibration module.

5. The bilateral stimulation device of claim 4, wherein the duration controller is configured to cycle through a predefined set of discrete duration values in response to actuation.

6. The bilateral stimulation device of claim 1, wherein the first handle extends in a longitudinal direction, defining a top side, a bottom side, a right side, a left side, a front side, and a back side, and the second handle extends in a longitudinal direction, defining a top side, a bottom side, a right side, a left side, a front side, and a back side.

7. The bilateral stimulation device of claim 1, wherein the first vibration module and the second vibration module are configured to alternately vibrate.

8. The bilateral stimulation device of claim 1, further comprising a first grip detector on the first handle and a second grip detector on the second handle.

9. The bilateral stimulation device of claim, 8 wherein the first grip detector and the second grip detector are configured to begin a stimulation session in response to detecting that the first handle and the second handle are gripped.

10. The bilateral stimulation device of claim 2, wherein the controller is configured to implement a ramp-up period and a ramp-down period, the ramp-up period being configured to increase the vibration characteristics after activation, the ramp-down period being configured to decrease the vibration characteristics prior to deactivation.

11. A bilateral stimulation device comprising:
a first handle operably coupled to a second handle;
at least one button arranged on each of the first handle and the second handle;
a first vibration module disposed in the first handle being configured to vibrate the first handle;
a second vibration module disposed in the second handle being configured to vibrate the second handle; and,
each of the at least one buttons being configured to directly control a stimulation parameter of the first vibration module and the second vibration module.

12. The bilateral stimulation device of claim 11, wherein one of the buttons further comprises a controller configured to adjust a stimulation parameter of the first vibration module and the second vibration module.

13. The bilateral stimulation device of claim 12, wherein the controller is configured to cycle through a predefined set of discrete values of the first stimulation parameter in response to actuation.

14. The bilateral stimulation device of claim 11, wherein one of the buttons further comprises a duration controller configured to control a vibration duration of the first vibration module and the second vibration module.

15. The bilateral stimulation device of claim 14, wherein the duration controller is configured to cycle through a predefined set of discrete duration values in response to actuation.

16. The bilateral stimulation device of claim 14, wherein the vibration duration is selectively configured to align with a breathing cycle.

17. The bilateral stimulation device of claim 11, wherein the first vibration module and the second vibration module are configured to alternately vibrate.

18. The bilateral stimulation device of claim 11, further comprising a first grip detector on the first handle and a second grip detector on the second handle.

19. The bilateral stimulation device of claim, 18 wherein the first grip detector and the second grip detector are configured to begin a stimulation session in response to detecting that the first handle and the second handle are gripped.

20. A bilateral stimulation device comprising:
first housing means and second housing means electrically coupled via a cable;
at least one button arranged on each of the first housing means and the second handle;
a first vibration module disposed in the first housing means being configured to vibrate the first handle;
a second vibration module disposed in the second housing means being configured to vibrate the second handle;
each of the at least one buttons being configured to directly control a stimulation parameter of the first vibration module and the second vibration module.
